(19) United States
(12) Patent Application Publication
(10) Pub. No.: US 2026/0038101 A1
(43) Pub. Date: Feb. 5, 2026

(54) Real-time visual damage detection of synthetic lifting ropes

(71) Applicant: Konecranes Global Oy, Hyvinkää (FI)

(72) Inventors: Tuomas JALONEN, Hyvinkää (FI); Mohammad AL-SA'D, Hyvinkää (FI); Roope MELLANEN, Hyvinkää (FI); Sami TERHO, Hyvinkää (FI); Kari RINTANEN, Hyvinkää (FI); Juhani KEROVUORI, Hyvinkää (FI); Heikki MESIÄ, Hyvinkää (FI)

(21) Appl. No.: 19/099,061

(22) PCT Filed: Jul. 24, 2023
(86) PCT No.: PCT/FI2023/050447

§ 371 Date: Jan. 28, 2025

(30) Foreign Application Priority Data
Jul. 29, 2022 (FI) 20225694

(51) Int. Cl. G06T 7/00

(52) U.S. Cl. CPC G06T 7/0002; G06T 2207/20081; G06T 2207/20084; G06T 2207/30136; G06T 2207/30168

(57) ABSTRACT

A method, apparatus, and system for real-time visual damage detection of a synthetic lifting rope, including winding (701) in or out a synthetic lifting rope by a crane; obtaining (702) a stream of photographic images of the rope while wound in or out by the crane; and detecting (703) damages in the rope using a convolution neural network CNN. Training of the CNN includes winding (704) in or out the rope under a tensile load; obtaining (705) a stream of photographic images of the rope while wound in or out under the tensile load; obtaining (706) two classified sets formed using the images comprising a first set of images classified as good, and a second set of images classified as not good: pre-processing (707) the images of the two sets; and feeding (708) the pre-processed images to the CNN.

### TECHNICAL FIELD

The present disclosure generally relates to real-time visual damage detection of synthetic lifting ropes.

### BACKGROUND

This section illustrates useful background information without admission of any technique described herein representative of the state of the art.

Cranes have traditionally used steel wires as lifting ropes. Synthetic lifting ropes are an alternative that is particularly well suited for some applications. Since the lifting rope forms a single point of failure, it is desirable to monitor damage of the rope.

There are numerous different damage detection methods for steel lifting ropes, but fewer for the synthetic ones. For example, electromagnetic detection, radiation testing, and eddy current inspection are among the main non-destructive testing methods for steel lifting ropes. However, these methods may be unsuitable for synthetic lifting ropes. Some other methods, such as ultrasonic guided wave evaluation, and optical detection may be usable for also synthetic lifting ropes. However, despite of research, there is still a need for more reliable and alternative methods for detecting damage of synthetic lifting ropes.

### SUMMARY

The appended claims define the scope of protection. Any examples and technical descriptions of apparatuses, products and/or methods in the description and/or drawings not covered by the claims are presented not as embodiments of the invention but as background art or examples useful for understanding the invention.

According to a first example aspect, there is provided a method for real-time visual damage detection of a synthetic lifting rope, comprising
winding in or out a synthetic lifting rope by a crane;
obtaining a stream of photographic images of the synthetic lifting rope while wound in or out by the crane; and
detecting damages in the synthetic lifting rope using a convolution neural network.

According to a second example aspect, there is provided a method for training a convolutional neural network for real-time visual damage detection of a synthetic lifting rope, comprising
winding in or out a synthetic lifting rope of a crane under a tensile load;
obtaining a stream of photographic images of the synthetic lifting rope while wound in or out under the tensile load;
obtaining two classified sets formed using the images comprising a first set of images classified as good, where the synthetic rope is classified as good, and a second set of images classified as not good, where the synthetic rope is classified as damaged;
pre-processing the images of the two sets; and
feeding the pre-processed images to a convolution neural network.

The obtaining of the stream of images may comprise taking photographs from two or more sides around the synthetic lifting rope. The photographs taken from the two or more sides around the synthetic lifting rope may be aligned in a longitudinal direction of the synthetic lifting rope.

The obtaining of the stream of images may comprise pre-processing the photographs for reducing computational complexity in the convolutional neural network. The pre-processing may comprise a histogram equalisation. The pre-processing may comprise converting the photographs to grayscale images, e.g., with 8 bits depth. The pre-processing may comprise reducing resolution of the photographs, e.g., to 32×32 pixels. The reducing of the resolution may comprise downsampling the photographs.

The convolution neural network may comprise two convolution layers in succession. The convolution neural network may comprise two convolution layers in succession before any pooling layer, such as a MaxPool layer.

The convolution neural network may be trained using an Adam optimiser. The Adam optimiser may be as disclosed in D. P. Kingma and J. Ba, “Adam: A method for stochastic optimization,” arXiv preprint arXiv: 1412.6980, 2014, https://doi.org/10.48550/arXiv.1412. 6980Focustolearnmore.

The convolution neural network may be trained for at least 100 epochs. The convolution neural network may be trained for at least 200 epochs. The convolution neural network may be trained for at least 300 epochs.

The convolution neural network may be trained with a learning rate set to decay by at least 10⁻³. The convolution neural network may be trained with a learning rate set to dynamically decay with two or more rates on respective ranges of epochs. The learning rate may be set to decay as: 10⁻³ for epochs 1 to 120; 10⁻⁴ for epochs 121 to 150; 10⁻⁵ for epochs 151 to 180, and 10⁻⁶ for epochs 181 to 200.

The convolution neural network may be trained with a batch size of 16. The convolution neural network may be trained with a batch size of 64. The convolution neural network may be trained with a batch size of 128.

The convolution neural network may be trained using a categorical cross-entropy as a loss function. Validation accuracy may be monitored during the training of the convolution neural network.

The visual damage inspection may be automatically performed, e.g., periodically, or repeatedly. The visual damage inspection may be automatically performed after each N days before starting first lifting task, N being one or more. The automatically performed visual damage inspection may comprise lifting a load to a given top position and lowering the load onto a ground or floor to obtain photographs between these two positions. The top position may be at a maximum lifting position of the crane. The bottom position may be at most 2 metres above a ground or floor level.

According to a third example aspect, there is provided an apparatus comprising at least one processor configured to cause performing the method of the first or second example aspect.

According to a fourth example aspect, there is provided an apparatus comprising means for performing the method of the first or second example aspect.

According to a fifth example aspect, there is provided a system comprising the apparatus of the third or fourth example aspect configured to perform the method of the first example aspect and the apparatus of the third or fourth example aspect configured to perform the method of the second example aspect.

According to a sixth example aspect, there is provided a computer program comprising computer executable program code which when executed by at least one processor causes an apparatus at least to perform the method of the first or second example aspect.

According to a seventh example aspect, there is provided a computer program product comprising a non-transitory computer readable medium having the computer program of the sixth example aspect stored thereon.

According to an eighth example aspect, there is provided an apparatus comprising means for performing the method of any preceding aspect.

According to a ninth example aspect, there is provided a system comprising
a crane comprising a synthetic rope hoisting element;
a camera system for taking photographs from at least two different sides of the synthetic rope when wound in or out by the hoisting element; and
the apparatus of claim 14 for real-time visual detection of damage in the synthetic hoist or for training a convolutional neural network for the real-time visual damage detection of the synthetic lifting rope.

The system may further comprise the synthetic rope. The synthetic rope may comprise polyethylene. At least 95 weight percent of synthetic rope may be polyethylene.

The system may comprise an on-line communication interface for sending visual damage detection information to a remote location. The system may further comprise a crane control element configured to prevent further use of the crane at least for new lifting tasks if visual damage detection indicates a damage in the synthetic rope. The prevented use may be reset, and new tasks allowed by the crane control element in response to receiving a remote or local permission to continue after a verification of the synthetic rope. The verification may be based on the photographs taken by the camera system.

According to a tenth example aspect, there is provided a method, apparatus, computer program, computer program product, or system according to any preceding example aspect, adapted to operate with a steel rope instead of, or alternating with synthetic ropes. Same equipment may be provided with two or more different convolutional neural networks optimised for respective two or more different types of ropes. The model to use may be automatically or manually chosen. The automatic choice may be at least partly based on detection of one or more electric or magnetic properties of the rope, and/or on images taken of the rope, e.g., colour(s), texture, and/or gloss of the rope material.

It may be particularly advantageous to provide for detecting damages of a steel lifting rope in nuclear plants, particularly high cranes such as gantry cranes, foundry cranes, and alpine or surface lifts, generally such applications wherein human access to the crane may be difficult. In nuclear and foundry applications, heat and/or radiation may prevent or make difficult to provide human access to the crane for rope damage detection.

Any foregoing memory medium may comprise a digital data storage such as a data disc or diskette; optical storage; magnetic storage; holographic storage; opto-magnetic storage; phase-change memory; resistive random-access memory; magnetic random-access memory; solid-electrolyte memory; ferroelectric random-access memory; organic memory; or polymer memory. The memory medium may be formed into a device without other substantial functions than storing memory or it may be formed as part of a device with other functions, including but not limited to a memory of a computer; a chip set; and a sub assembly of an electronic device.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE FIGURES

Some example embodiments will be described with reference to the accompanying figures, in which:

FIG. 1 schematically shows a system according to an example embodiment;

FIGS. 2a to 2d illustrate sample images (OK) through different phases of pre-processing, according to an example embodiment;

FIGS. 3a to 3d illustrate sample images (OK) through different phases of pre-processing, according to an example embodiment;

FIGS. 4a to 4d illustrate sample images (Not OK) through different phases of pre-processing, according to an example embodiment;

FIGS. 5a to 5d illustrate sample images (Not OK) through different phases of pre-processing, according to an example embodiment;

FIG. 6 shows a block diagram of an apparatus according to an example embodiment; and

FIGS. 7a and 7b show a flow chart according to an example embodiment.

### DETAILED DESCRIPTION

In the following description, like reference signs denote like elements or steps.

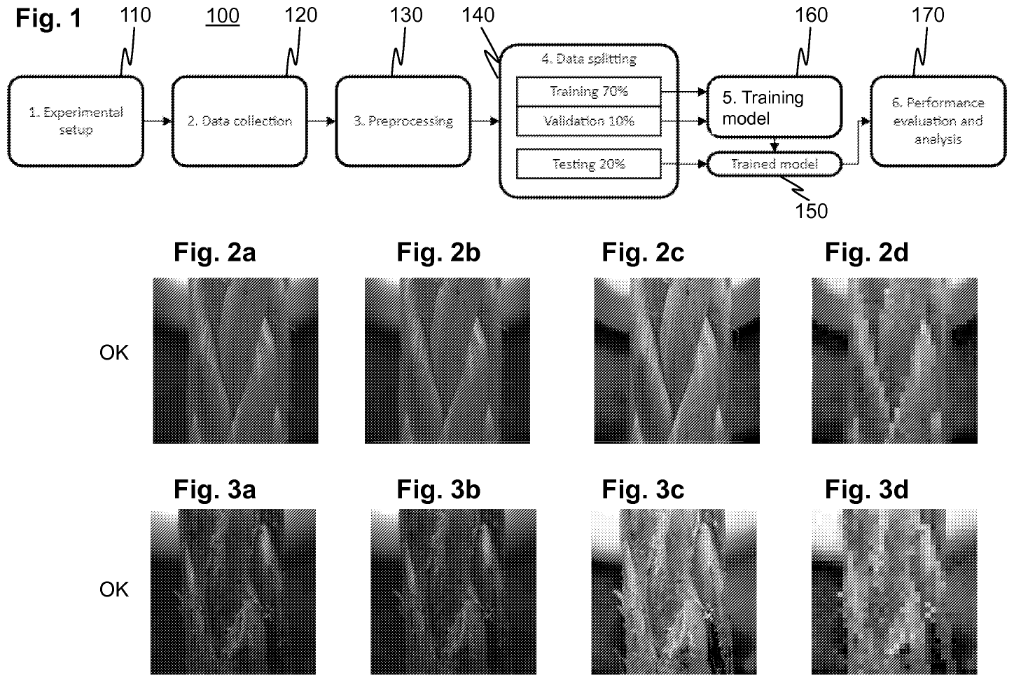

FIG. 1 schematically shows a system according to an example embodiment.

The system 100 comprises a camera system 110 comprising three cameras configured to image a synthetic rope from three different sides with an even spacing of 120 degrees. The captured images are stored into an image storage 120. A pre-processing circuitry 130 enhances the captured images and reduces their resolution and colour space to be better suited for a deep learning model 150, here a convolutional neural network, CNN. The pre-processed images are fed to a data splitter 140 that splits the pre-processed images into three baskets with representative choice of pre-processed images. These baskets are testing images to be used by a training element 160 for: testing the deep learning model; training images; and validation images for collectively training the deep learning model or CNN 150. The training element 160 also produces the trained model to which the testing images are fed. Resulting classification of the test images is fed by the trained model to a performance evaluation and analysis circuitry.

The test images are classified by a trusted classifier, such as a reliably trained deep learning model or one or more human experts, into good (OK) and bad (not ok, NOK) images representing good and bad portions in the synthetic rope.

In an example embodiment, the pre-processing comprises a histogram equalisation, followed by reduction of colour depth, e.g., from three 14-bit colour channels to one 8-bit grayscale, and reduction of resolution, e.g., by down sampling to 32×32 pixels.

FIGS. 2a to 2d illustrate sample images through different phases of the pre-processing, according to an example embodiment. FIG. 2a is a grayscale version of an original image of a nearly new synthetic rope. FIG. 2b shows same in 8 bit colour depth, FIG. 2c as histogram equalised, and FIG. 2d in resolution lowered to 32×32 pixels.

FIGS. 3a to 3d illustrate a similar series of a more worn synthetic rope with some signs of wear, but still classified as good. Despite of the relatively low resolution, there is a clear difference between FIGS. 2d and 3d.

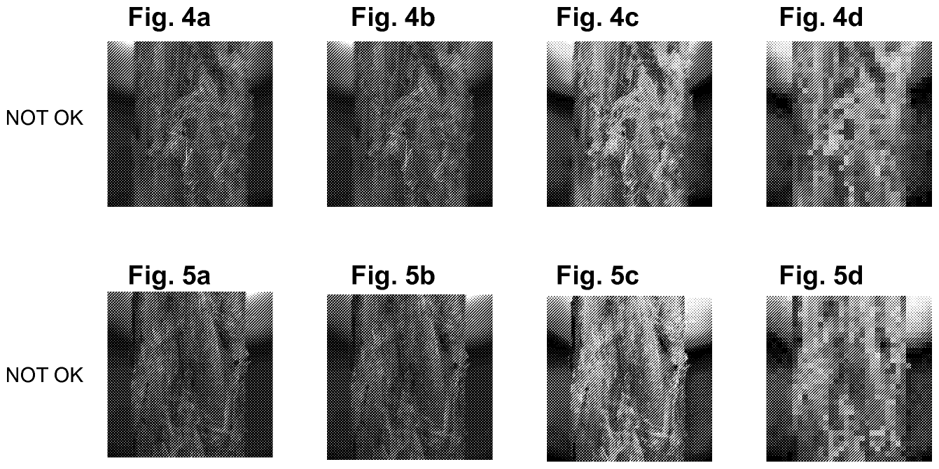

FIGS. 4a to 4d and FIGS. 5a to 5d illustrate two sample images (Not OK) through different phases of pre-processing, according to an example embodiment. These images clearly visualise that somewhat surprisingly, the 32×32 pixel resolution is sufficient to show damage in the synthetic rope.

An example of a CNN proposal CNN-p is next described. The convolution neural network comprises the following layers in this order: first convolution layer, second convolution layer, first MaxPool layer, first dropout layer, third convolution layer, second MaxPool layer, second dropout layer, flatten layer, third dropout layer, first dense layer, fourth dropout layer, and second dense layer.

The first convolution layer is configured with L2 kernel regulation 0.0005, L2 bias regulation 0.0005, kernel size 3×3, and activation by rectified linear units, ReLU. The output shape of the first convolution layer is 30×30×64. The first convolution layer has 640 parameters.

The second convolution layer is configured with L2 kernel regulation 0.0005, L2 bias regulation 0.0005, kernel size 3×3, and activation by rectified linear units, ReLU. The output shape of the second convolution layer is 28×28×64. The second convolution layer has 36 928 parameters.

The first MaxPool layer has a pool of 2×2. The first MaxPool layer has an output shape of 14×14×64. The first MaxPool layer has 0 parameters.

The first dropout layer has a rate of 0.4. The first dropout layer has an output shape of 14×14×64. The first dropout layer has 0 parameters.

The third convolution layer is configured with L2 kernel regulation 0.0005, L2 bias regulation 0.0005, kernel size 3×3, and activation by rectified linear units, ReLU. The output shape of the third convolution layer is 12×12×64. The third convolution layer has 36 928 parameters.

The second MaxPool layer has a pool of 2×2. The second MaxPool layer has an output shape of 6×6×64. The second MaxPool layer has 0 parameters.

The second dropout layer has a rate of 0.4. The second dropout layer has an output shape of 6×6×64. The second dropout layer has 0 parameters.

The flatten layer has an output shape of 2 304. The flatten layer has no parameters.

The third dropout layer has a rate of 0.4. The third dropout layer has an output shape of 2 304. The third dropout layer has 0 parameters.

The first dense layer is configured with activation by rectified linear units, ReLU. The output shape of the first dense layer is 20. The first dense layer has 46 100 parameters.

The fourth dropout layer has a rate of 0.2. The fourth dropout layer has an output shape of 20. The fourth dropout layer has 0 parameters.

The second dense layer is configured with activation by Softmax. The output shape of the second dense layer is 2. The second dense layer has 42 parameters.

In total, the CNN-p layers have 120 683 parameters.

In an example embodiment, the deep learning model is designed aiming to enable real-time execution and light computational cost. To this end, the layers have a succession of two convolution layers before a first MaxPool layer.

The CNN-p model was evaluated against two reference models. These two reference models are called here as model A and model B. Model A is based a neural network model disclosed in Z. Ping, Z. Gongbo, L. Yingming, and H. Zhenzhi, “Surface defect detection for wire ropes based on deep convolutional neural network,” in 2019 14th IEEE International Conference on Electronic Measurement Instruments (ICEMI), 2019, pp. 855-860, and particularly the model WRIPDCNN1 was used. Model B is based on a neural network disclosed in P. Zhou, G. Zhou, H. Wang, D. Wang, and Z. He, “Automatic Detection of Industrial Wire Rope Surface Damage Using Deep Learning-Based Visual Perception Technology,” IEEE Transactions on Instrumentation and Measurement, vol. 70, pp. 1-11, 2021. The models A and B were adopted for comparison with the CNN-p as disclosed in the following. Model A was modified by changing the output shape to 2 to match current problem definition, good/bad. Moreover, six dropout layers were added with 0.5 rate to mitigate overfitting problems of the model. Model B was modified by increasing the network original two dropout rates to 0.6 and adding three more layers to mitigate overfitting.

Model A is a convolution neural network comprising the following layers in this order: first convolution layer, first MaxPool layer, second convolution layer, second MaxPool layer, first dropout layer, third convolution layer, third MaxPool layer, second dropout layer, fourth convolution layer, fourth MaxPool layer, third dropout layer, flatten layer, fourth dropout layer, first dense layer, fifth dropout layer, second dense layer, sixth dropout layer, and third dense layer. The first convolution layer has a 5×5 kernel and ReLU activation, 64×64×32 output shape, and 832 parameters. The first MaxPool layer has a 2×2 pool, 32×32×32 output shape, and 0 parameters. The second convolution layer has a 3×3 kernel and ReLU activation, 32×32×64 output shape, and 18 496 parameters. The second MaxPool layer has a 2×2 pool, 16×16×64 output shape, and 0 parameters. The first dropout layer has a rate of 0.5, 16×16×64 output shape, and 0 parameters. The third convolution layer has a 3×3 kernel and ReLU activation, 16×16×128 output shape, and 73 856 parameters. The third MaxPool layer has a 2×2 pool, 8×8×128, and 0 parameters. The second dropout layer has a rate of 0.5, 8×8×128 output shape, and 0 parameters. The fourth convolution layer has a 3×3 kernel, ReLU activation, 8×8×256 output shape, and 295 168 parameters. The fourth MaxPool layer has a 2×2 pool, 4×4×256 output shape, and 0 parameters. The third dropout layer has a rate of 0.5, 4×4×256 output shape, and 0 parameters. The flatten layer has 4 096 output shape, and 0 parameters. The fourth dropout layer has a rate of 0.5, 4 096 output shape, and 0 parameters. The first dense layer has ReLU activation, 2 560 output shape, and 10 488 320 parameters. The fifth dropout layer has a rate of 0.5, 2 560 output shape, and 0 parameters. The second dense layer has ReLU activation, 768 output shape, and 1 966 848 parameters. The sixth dropout layer has a rate of 0.5, 768 output shape, and 0 parameters. The third dense layer has Softmax activation, 2 output shape, and 1 538 parameters. Total number of parameters is 12 845 058.

Model B is a convolution neural network comprising the following layers in this order: first convolution layer, first MaxPool layer, second convolution layer, second MaxPool layer, third convolution layer, third MaxPool layer, first dropout layer, fourth convolution layer, fourth MaxPool layer, second dropout layer, flatten layer, third dropout layer, first dense layer, fourth dropout layer, second dense layer, fifth dropout layer, and third dense layer. The first convolution layer has a 5×5 kernel and ReLU activation, 96×96×16 output shape, and 416 parameters. The first MaxPool layer has a 2×2 pool, 48×48×16 output shape, and 0 parameters. The second convolution layer has a 3×3 kernel and ReLU activation, 48×48×32 output shape, and 4 640 parameters. The second MaxPool layer has a 2×2 pool, 24×24×32 output shape, and 0 parameters. The third convolution layer has a 3×3 kernel and ReLU activation, 24×12×64 output shape, and 18 496 parameters. The third MaxPool layer has a 2×2 pool, 12×12×64, and 0 parameters. The first dropout layer has a rate of 0.6, 12×12×64 output shape, and 0 parameters. The fourth convolution layer has a 3×3 kernel, ReLU activation, 12×12×96 output shape, and 55 392 parameters. The fourth MaxPool layer has a 2×2 pool, 6×6×96 output shape, and 0 parameters. The second dropout layer has a rate of 0.6, 6×6×96 output shape, and 0 parameters. The flatten layer has 3 456 output shape, and 0 parameters. The third dropout layer has a rate of 0.6, 3456 output shape, and 0 parameters. The first dense layer has ReLU activation, 120 output shape, and 414 840 parameters. The fourth dropout layer has a rate of 0.6, 120 output shape, and 0 parameters. The second dense layer has ReLU activation, 32 output shape, and 3 872 parameters. The fifth dropout layer has a rate of 0.6, 32 output shape, and 0 parameters. The third dense layer has Softmax activation, 2 output shape, and 66 parameters. Total number of parameters is 497 722.

The models were trained for 200 Epochs using the Adam optimiser. The learning rate was scheduled to decay as: 10⁻³ for epochs 1 to 120; 10⁻⁴ for epochs 121 to 150; 10⁻⁵ for epochs 151 to 180, and 10⁻⁶ for epochs 181 to 200. Batch size was 128. The loss function was defined by categorical cross-entropy.

In the performance analysis, model A correctly classified 1735 good and 1938 bad images, while erroneously classifying 267 good and 64 bad images. Model B correctly classified 1845 good and 1936 bad images, while erroneously classifying 138 good and 66 bad images. The currently developed CNN model, CNN proposal or CNN-p, correctly classified 1864 good images and 1931 bad images, while erroneously classifying 138 good images and 71 bad images. For the intended use, it may be more important to avoid errors in classifying images as good than to avoid errors in classifying images as bad. In terms of accuracy, the CNN-p also slightly won model B by 0.948 against 0.944 and model A with its 0.917. In other words, it was shown that the CNN-p works well while compacted down to run in real time with a 40 frames per second rate with a commercially available Apple MacBook Pro having an M1 Pro chip, 10-core CPU with integrated 16-core GPU, a 16 core neural engine, and 16 GB of RAM, even though experimental code was written in Python 3.9.7 rather than some faster language, such as C++. The model size of CNN-p was only 730 KB in comparison to 51.6 MB and 2.25 MB that were obtained with models A and B, respectively. The CNN-p had 120 683 parameters while models A and B had 12.8 million and 498 thousand parameters, respectively. The pre-processing also produced smaller images at 1.05 KB as opposed to 3.59 and 7.42 of models A and B, respectively. The processing rate was 39.5 frames per second as opposed to 32.5 and 33.3 with models A and B, respectively.

In a receiver operating characteristic curve, ROC, the area under the curve, AUC, was 0.986 for the CNN-p, 0.976 for model A, and 0.986 for model B.

The proposed CNN Grad-CAM heatmaps were obtained for two correctly detected damaged ropes. The heatmaps indicated model as adequate by focusing on the pixels that are relevant for the visual detecting of damage in the synthetic rope.

In an example embodiment, the training dataset is increased from the one used for CNN-p (20 008) with different rope sizes and types for improved generalisation of the model.

In an example embodiment, rope position information is integrated for damage localisation. In an example embodiment, the rope position is determined using an electric drive of the crane. In an example embodiment, the rope position is determined using optical analysis based on the output of the camera system 110. In an example embodiment, the rope position determination compensates for rope stretching. For example, the system 100 may estimate stretching of the rope under current loading and/or number of lifting operations and/or a combined effect of loading time and number of lifting operations.

In an example embodiment, the model is extended to classify a larger range than just good and bad. For example, the model can be extended to classify into three categories, such as good/moderate/bad. In such a case, the one or more intermediate categories are usable for different action. In an example embodiment, the classification results or classification results worse than good are presented with indications of time, camera in question, and/or rope position, such as length position. For example, rope damage estimated as damage may be manually verified in a next periodical maintenance, whereas more severe categories may be used to trigger more urgent verification and/or stop operation of the crane until the rope has been verified and/or replaced to a new one.

In an example embodiment, the classification is subsequently verified for at least some of the images. In an example embodiment, the verification of the classification is used to further train the deep learning model for enhancing precision thereof.

In an example embodiment, the classification results or classification results worse than good are shown for a given portion of the rope, such as the portion that is presently at a given position, e.g., at a distance of 20 cm to 1 m from the camera system 110.

In an example embodiment, the system 100 enables local connecting to the classified images of the rope for showing findings to service personnel on site. In an example embodiment, the classification results are displayed as diagrams for each of the cameras of the camera system 110 as a function of rope position while the rope is wound in or out. Particularly with the local connection to the system, maintenance personnel may conveniently identify suspected damage positions and manually verify the condition of the rope at respective positions. In an example embodiment, the system causes winding suspect portions at a particular inspection location, stopping the winding, and/or displaying the images of the rope that caused the classification as not good. In an example embodiment, the deep learning model is used to form a heat map of most significant parts of the image for the classification result and the heat map is displayed to the maintenance personnel for quicker verification of the classification.

In an example embodiment, the system 100 is configured to form an image series of same rope surface section that has been classified as not good. In an example embodiment, the image series is displayed as a transition image or video indicating how the condition of the rope has changed over time. The system may be further configured to estimate that how the rope would change in future and/or when the rope condition would reach a predetermined critical condition in which predetermined conditions are met, such as a minimum rope thickness, maximum number of broken strands, and/or minimum contrast between an estimated nominal surface of the rope and proximate area around the rope.

In an example embodiment, images of the rope as captured by each camera from different sides of the rope are presented in parallel for presenting a 360 degree view of the rope.

In an example embodiment, same classification is used in the training and production use of the deep learning model.

In an example embodiment, the method further comprises automatically issuing a signal in response to detecting that the synthetic rope should be replaced. In an example embodiment, the signal is used to stop operation of the crane for new lifting tasks until the synthetic rope has been manually verified.

In an example embodiment, one apparatus implements any one or more of the image storage 120, pre-processing circuitry 130, data splitter 140, deep learning model, trained model, and/or the performance evaluation and analysis.

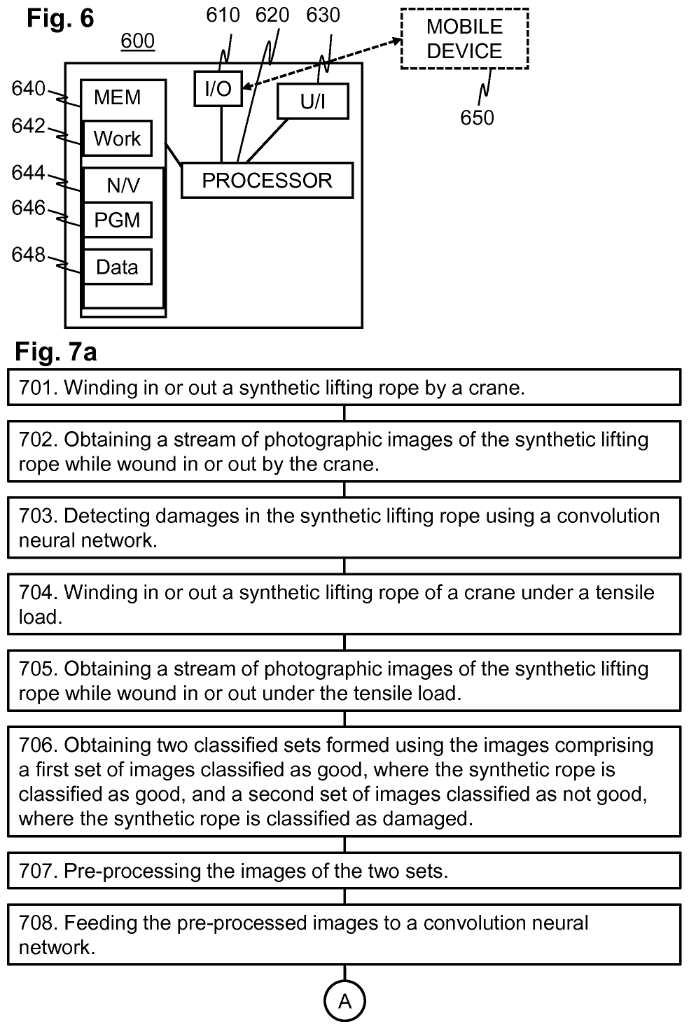

FIG. 6 shows a block diagram of an apparatus 600 and of a mobile device 650 according to an example embodiment for implementing any one or more of the afore-mentioned elements. The apparatus 600 comprises a communication interface 610; a processor 620; a user interface 630; and a memory 640.

The communication interface 610 comprises in an embodiment a wired and/or wireless communication circuitry, such as Ethernet; Wireless LAN; Bluetooth; GSM; CDMA; WCDMA; LTE; and/or 5G circuitry. The communication interface can be integrated in the apparatus 600 or provided as a part of an adapter, card or the like, that is attachable to the apparatus 600. The communication interface 610 may support one or more different communication technologies. The apparatus 600 may also or alternatively comprise more than one of the communication interfaces 610.

In this document, a processor may refer to a central processing unit (CPU); a microprocessor; a digital signal processor (DSP); a graphics processing unit; an application specific integrated circuit (ASIC); a field programmable gate array; a microcontroller; or a combination of such elements.

The user interface may comprise a circuitry for receiving input from a user of the apparatus 600, e.g., via a keyboard; graphical user interface shown on the display of the apparatus 600; speech recognition circuitry; or an accessory device; such as a headset; and for providing output to the user via, e.g., a graphical user interface or a loudspeaker.

The memory 640 comprises a work memory 642 and a persistent memory 644 configured to store computer program code 646 and data 648. The memory 640 may comprise any one or more of: a read-only memory (ROM); a programmable read-only memory (PROM); an erasable programmable read-only memory (EPROM); a random-access memory (RAM); a flash memory; a data disk; an optical storage; a magnetic storage; a smart card; a solid-state drive (SSD); or the like. The apparatus 600 may comprise a plurality of the memories 640. The memory 640 may be constructed as a part of the apparatus 600 or as an attachment to be inserted into a slot; port; or the like of the apparatus 600 by a user or by another person or by a robot. The memory 640 may serve the sole purpose of storing data, or be constructed as a part of an apparatus 600 serving other purposes, such as processing data.

In an example embodiment, the processor 620, the memory 640, and the computer program code are collectively configured to implement a web server for allowing access to the system 100 from the site and/or remotely. In an example embodiment, the system is configured to enable using the mobile device 650 such as a tablet computer or mobile phone to display information by the system and/or to receive user input, e.g., over a wireless or wired connection. In an example embodiment, the mobile device is usable to verify or adjust positions and/or orientations of the cameras of the camera system 110.

A skilled person appreciates that in addition to the elements shown in FIG. 6, the apparatus 600 may comprise other elements, such as microphones; displays; as well as additional circuitry such as input/output (I/O) circuitry; memory chips; application-specific integrated circuits (ASIC); processing circuitry for specific purposes such as source coding/decoding circuitry; channel coding/decoding circuitry; ciphering/deciphering circuitry; and the like. Additionally, the apparatus 600 may comprise a disposable or rechargeable battery (not shown) for powering the apparatus 600 if external power supply is not available.

In an example embodiment, only a single neural network is used to for visual damage detection, using solely the image data. Doing so avoids complexities arising if, for example, multiple separate neural networks were used, optionally in addition to further information such as some electromagnetic measurements.

In an example embodiment, the neural network is trained from scratch instead of transferring learning to one or more neural networks.

In an example embodiment, the images are classified without preceding other classification methods. In an example embodiment, the images are classified into two categories, good or not good.

In an example embodiment, each image is classified as a whole.

In an example embodiment, the images are downsized such that the processing is significantly accelerated.

In an example embodiment, the images are taken with a frame rate of at least 35 frames per second or of at least 40 frames per second.

In an example embodiment, the real-time visual damage detection can be performed on less powerful computing devices and with smaller memory and power consumption in comparison to known prior art solutions. Moreover, the training may be faster when new rope types are introduced.

In an example embodiment, the lifting rope has a round cross-section. A round cross-section may help to reduce issues caused by the rope potentially twisting about its longitudinal direction on winding onto a rope drum, for example. A round lifting rope also differs from belts and chains in that the orientation of any given patch on the rope side changes when in use. Hence, the position of particular damage on the rope may laterally change position or be divided into two or more images in a new manner. This may further explain that why a relatively low image resolution seems to work fine in a real-time visual damage detection. Notably, various damages manifest very differently in different types of ropes and other lifting media. Even materials used in roller elements may have impact this. Moreover, steel ropes have completely different damage manifestation. A simple cut in steel wire is completely different from a fibre level damage that occurs in synthetic ropes, not to mention other possible damage types. Hence, it is far from apparent that any algorithms developed for a steel rope would properly work as an indicator of condition or remaining strength of a synthetic rope.

Various damage type manifestations are next compared between synthetic and steel ropes.

Damage type comparison of synthetic ropes with steel wires:

| | |
|---|---|
| Abrasion (internal/external) | Dissimilar to steel wire rope |
| Broken strands (partial/full) | Dissimilar to steel wire rope |
| Strand separation | Somewhat similar to birdcage |
| Melted fibres | Dissimilar to steel wire rope |
| Contamination | Different contaminants relevant |
| Diameter (increased/decreased) | Dissimilar to steel wire rope* |
| Twist | Similar if rope is loaded, but |
| | dissimilar without load |

*Both have diameter changes, but they occur for a variety of reasons and can look very different.

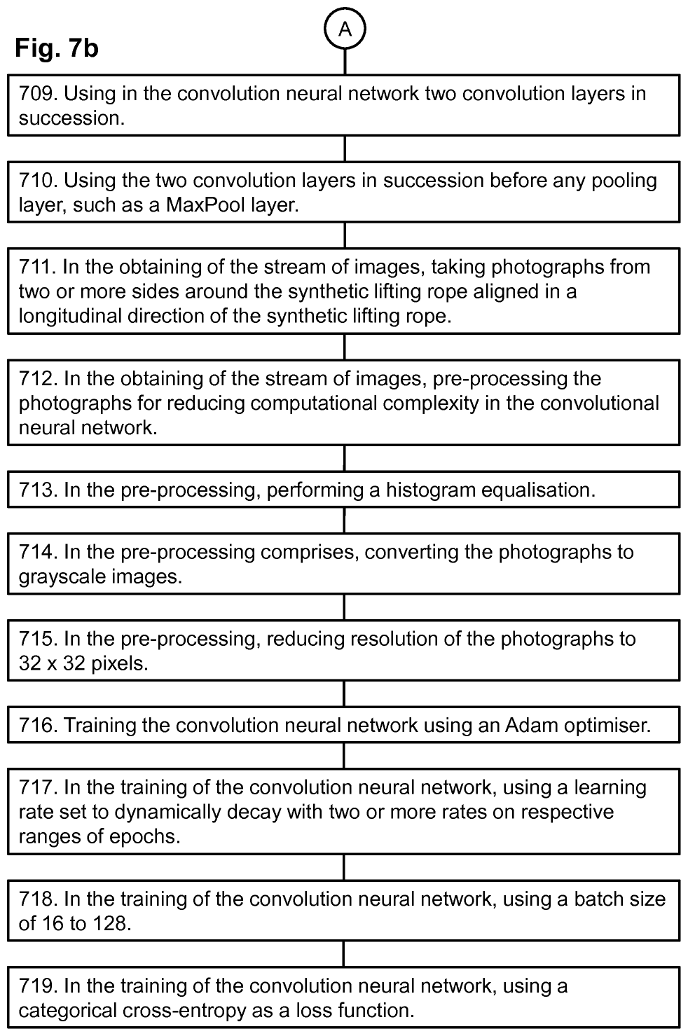

FIGS. 7a and 7b show a flow chart according to an example embodiment, illustrating various possible steps including some optional steps while also further steps can be included and/or some of the steps can be performed more than once or in a different order, comprising
701. Winding in or out a synthetic lifting rope by a crane.
702. Obtaining a stream of photographic images of the synthetic lifting rope while wound in or out by the crane.
703. Detecting damages in the synthetic lifting rope using a convolution neural network.
704. Winding in or out a synthetic lifting rope of a crane under a tensile load.
705. Obtaining a stream of photographic images of the synthetic lifting rope while wound in or out under the tensile load.
706. Obtaining two classified sets formed using the images comprising a first set of images classified as good, where the synthetic rope is classified as good, and a second set of images classified as not good, where the synthetic rope is classified as damaged.
707. Pre-processing the images of the two sets.
708. Feeding the pre-processed images to a convolution neural network.
709. Using in the convolution neural network two convolution layers in succession.
710. Using the two convolution layers in succession before any pooling layer, such as a MaxPool layer.
711. In the obtaining of the stream of images, taking photographs from two or more sides around the synthetic lifting rope aligned in a longitudinal direction of the synthetic lifting rope.
712. In the obtaining of the stream of images, pre-processing the photographs for reducing computational complexity in the convolutional neural network.
713. In the pre-processing, performing a histogram equalisation.
714. In the pre-processing comprises, converting the photographs to grayscale images.
715. In the pre-processing, reducing resolution of the photographs to 32×32 pixels.
716. Training the convolution neural network using an Adam optimiser.
717. In the training of the convolution neural network, using a learning rate set to dynamically decay with two or more rates on respective ranges of epochs.
718. In the training of the convolution neural network, using a batch size of 16 to 128.
719. In the training of the convolution neural network, using a categorical cross-entropy as a loss function.

A technical effect of one or more example embodiments is that a visual damage detection may be automatically arranged in real time with a modest model memory and processing requirement. Another technical effect of one or more example embodiments is that a visual damage detection may be automatically performed with good prediction ability, particularly with reduced likelihood of erroneous classification of a damaged rope section as good. Yet another technical effect of one or more example embodiments is that a visual damage detection may be automatically performed without hindering normal use of the crane in which the synthetic rope is installed.

Any of the afore described methods, method steps, or combinations thereof, may be controlled or performed using hardware; software; firmware; or any combination thereof. The software and/or hardware may be local; distributed; centralised; virtualised; or any combination thereof. Moreover, any form of computing, including computational intelligence, may be used for controlling or performing any of the afore described methods, method steps, or combinations thereof. Computational intelligence may refer to, for example, any of artificial intelligence; neural networks; fuzzy logics; machine learning; genetic algorithms; evolutionary computation; or any combination thereof.

Various embodiments have been presented. It should be appreciated that in this document, words comprise; include; and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1. A method for real-time visual damage detection of a synthetic lifting rope, comprising
winding in or out a synthetic lifting rope by a crane;
obtaining a stream of photographic images of the synthetic lifting rope while wound in or out by the crane; and
detecting damages in the synthetic lifting rope using a convolution neural network configured to classify the obtained images as good or not good.

2. A method for training a convolutional neural network for real-time visual damage detection of a synthetic lifting rope, comprising
winding in or out a synthetic lifting rope of a crane under a tensile load;
obtaining a stream of photographic images of the synthetic lifting rope while wound in or out under the tensile load;
obtaining two classified sets formed using the images comprising a first set of images classified as good, where the synthetic rope is classified as good, and a second set of images classified as not good, where the synthetic rope is classified as damaged;
pre-processing the images of the two sets; and
feeding the pre-processed images to a convolution neural network.

3. The method of claim 2, wherein the convolution neural network comprises two convolution layers in succession.

4. The method of claim 3, wherein the two convolution layers in succession are before any pooling layer, such as a MaxPool layer.

5. The method of claim 2, wherein the obtaining of the stream of images comprises taking photographs from two or more sides around the synthetic lifting rope aligned in a longitudinal direction of the synthetic lifting rope.

6. The method of claim 2, wherein the obtaining of the stream of images comprises pre-processing the photographs for reducing computational complexity in the convolutional neural network, and
wherein the pre-processing comprises at least one of: a histogram equalization converting the photographs to grayscale images, and reducing resolution of the photographs to 32×32 pixels.

7. (canceled)

8. (canceled)

9. (canceled)

10. The method of claim 2, wherein the convolution neural network is trained using an Adam optimiser.

11. The method of claim 2, wherein the convolution neural network is trained with a learning rate set to dynamically decay with two or more rates on respective ranges of epochs.

12. The method of claim 2, wherein the convolution neural network is trained with a batch size of 16 to 128.

13. The method of claim 2, wherein the convolution neural network is trained using a categorical cross-entropy as a loss function.

14. An apparatus comprising:
at least one memory comprising computer executable program code; and
at least one processor configured cause the apparatus to perform, when executing the program code, at least cause the apparatus to perform the method of claim 1.

15. (canceled)

16. A system comprising:
at least one memory comprising computer executable program code; and
at least one processor configured cause the apparatus to perform, when executing the program code, at least cause the apparatus to perform the method of claim 2.

17. The system of claim 16, further comprising
a crane comprising a synthetic rope hoisting element; and
a camera system for taking photographs from at least two different sides of the synthetic rope when wound in or out by the hoisting element.

18. The method of claim 1, wherein the convolution neural network comprises two convolution layers in succession.

19. The method of claim 2, wherein the two convolution layers in succession are before any pooling layer, such as a MaxPool layer.

20. The method of claim 1, wherein the obtaining of the stream of images comprises taking photographs from two or more sides around the synthetic lifting rope aligned in a longitudinal direction of the synthetic lifting rope.

21. The method of claim 1, wherein
the obtaining of the stream of images comprises pre-processing the photographs for reducing computational complexity in the convolutional neural network, and
the pre-processing comprises
a histogram equalization;
converting the photographs to grayscale images; or
reducing resolution of the photographs to 32×32 pixels.

22. The method of claim 1, wherein the convolution neural network is trained with a learning rate set to dynamically decay with two or more rates on respective ranges of epochs.

23. The method of claim 1, wherein the convolution neural network is trained with a learning rate set to dynamically decay with two or more rates on respective ranges of epochs.

24. The method of claim 1, wherein the convolution neural network is trained using a categorical cross-entropy as a loss function.
